(19) United States
(12) Patent Application Publication
(10) Pub. No.: US 2008/0256534 A1
(43) Pub. Date: Oct. 16, 2008

(54) METHOD FOR IMPROVED IMAGE-CUSTOMIZATION BY USE OF EMBEDDED METADATA

(75) Inventors: David M. Chess, Mohegan Lake, NY (US); Sean L. Dague, Poughkeepsie, NY (US); Tamar Eilam, New York, NY (US); Ronald T. Goering, Austin, NY (US); Ryan P. Grimm, Cedar, TX (US); James E. Hanson, Yorktown Heights, NY (US); Giovanni Pacifici, New York, NY (US); Benny Rochwerger, Zichron Yaakov (IL); Hidayatullah H. Shaikh, Mohegan Lake, NY (US); Ian N. Whalley, Pawling, NY (US); Jian Yin, Bronx, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/734,549

(22) Filed: Apr. 12, 2007

(51) Int. Cl. G06F 9/455

(52) U.S. Cl. 718/1

(57) ABSTRACT

The present invention relates to a method for the customization of virtual machine images. The method comprises identifying and retrieving a virtual machine image template. A customized virtual machine image is created from the virtual machine image template. The customized virtual machine image template being created by identifying at least one file-system or memory image that is associated with the virtual machine image template, identifying within the at least one file-system or memory image at least one data set, wherein the at least one data set comprises metadata. The metadata contains information detailing the required execution context customization aspects for at least one specified image subset of the virtual machine. Execution context-specific information that is required to customize the image subset of the virtual machine is retrieved. Further, the image subset of the virtual machine is modified in accordance with the retrieved execution context-specific information.

### BACKGROUND OF TOE INVENTION

1. Field of the Invention

This invention relates to the creation of virtual machine templates, and particularly to the customization of virtual machine templates by the use of metadata.

2. Description of Background

Virtualization, including server virtualization that is implemented via virtual machines, has become an increasingly important aspect of IT systems management. A powerful use of virtualization involves the creation of one or more virtual machines from a master template by customizing specific information within the template according to the desired properties of the particular virtual machine or machines that are to be created and in relation to the environment in which the virtual machines will run.

Typically, virtual machine template customization can be a potentially complex task. Multiple levels of a software stack (from the operating system up through middleware, containers, and applications) may contain configuration or data items (e.g., such as the local hostname, encryption keys, names or URLs of other machines or services that they need to contact, the name of the local datacenter, user authorization levels, etc.) that need to be modified for the specific environment in which virtual machines that are created from the template will be run. Manually analyzing each level of the stack to determine what customization is needed is a complex and error-prone procedure. And in many cases, manual analysis of a stack may not be possible. Further, the automatic extraction of the data is also difficult and likely to be unreliable in many cases.

There is known art that is dedicated to the customization of an operating system configuration within a single virtual-machine template to reflect a particular IP address and/or hostname of a virtual machine that is to be created. When that customization is specific to the particular version of the operating system to be used in the virtual machine (this applies only to the operating system layer of the stack), this aspect requires the manual re-determining of the location of the customization points for each new version of the operating system, wherein customizing is restricted to those particular data items.

Presently, there exists a need for a methodology for virtual machine image customization, wherein software artifacts within a software stack are identified in a manner that allows a standard customization algorithm to locate and customize the required virtual machine generating data.

### SUMMARY OF THE INVENTION

The shortcomings of the prior art are overcome and additional advantages are provided through the provision of a method for the customization of virtual machine images. The method comprises identifying a template for the creation of a virtual machine image, and retrieving the virtual machine image template. The method further comprises creating a customized virtual machine image from the virtual machine image template. The customized virtual machine image template being created by identifying at least one file-system or memory image that is associated with the virtual machine image template, identifying within the at least one file-system or memory image at least one data set, wherein the at least one data set comprises metadata, the metadata containing information detailing the required execution context customization aspects for at least one specified image subset of the virtual machine, and retrieving execution context-specific information that is required to customize the image subset of the virtual machine. Further, the method comprises modifying the image subset of the virtual machine, wherein the image subset of the virtual machine is modified in accordance with the retrieved execution context-specific information.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a flow diagram detailing aspects of an image customization method.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art.

Aspects of the present invention relate to a method of image customization that allows the creators or packagers of software artifacts at various levels of a software stack to “mark-up” their software artifacts (in particular the files and directories that the artifacts create and use on a disk). The software artifacts are marked-up in such a way that enables a standard customization algorithm to correctly and reliably find and customize all the required artifact data when making a new virtual machine from a template.

For each software artifact in the software stack that requires customization there is a piece of metadata stored in the template that describes how to perform the customization that is relevant to a particular software artifact. This metadata may be created by the software artifact itself (e.g., by its installation program), by the packager or reseller of the artifact or by any other party. Further, the created metadata is sufficient to allow a general customization program, that is aware of the syntax and meaning of the metadata and of the conditions under which the virtual machine(s) to be created will run, to perform the necessary software artifact customization, either before each virtual machine is created or after the virtual machine starts up.

Within aspects of some embodiments of the present invention, the metadata is stored within the image in particular files with a standard name (such as “customization.xml”) anywhere in the file system contained within the image. In further embodiments, the metadata is stored in files whose names match a particular pattern (e.g., customization_APPLICATIONNAME_UUID.xml) in the root, or other well-known location (such, as “/var/lib”), in that file system, or in files with arbitrary names contained within directories or directory trees with standard names or names matching a particular pattern. In yet further embodiments, the files containing the metadata are listed in an index file with a standard well-known name, and both the metadata files and the index file are stored within the file system.

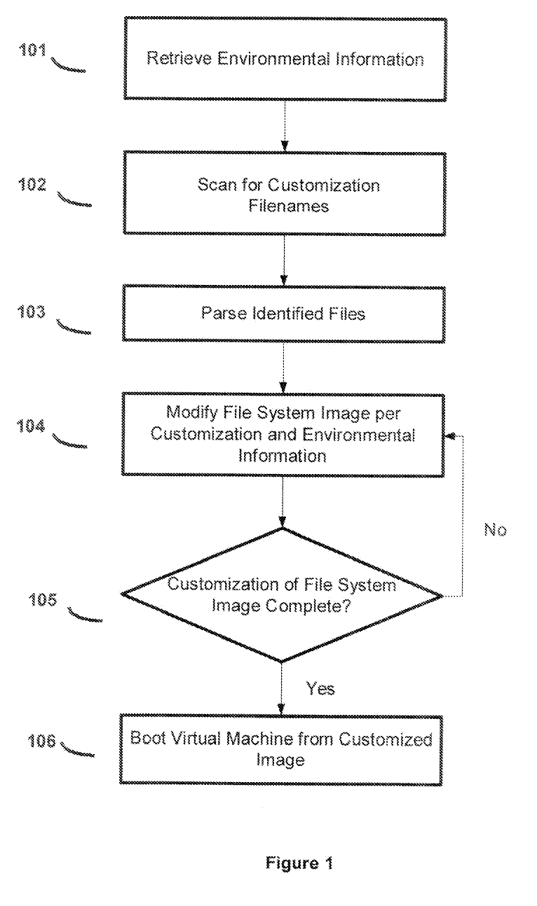

Turning now to the drawings in greater detail, it will be seen that in FIG. 1 there is a flow diagram detailing the virtual machine customization methodology of the present invention. At step 101, information pertaining to the environment in which the new virtual machine will be running is retrieved (e.g., information such as IP address, hostname, local netmask and gateway address, contact information for local directory servers, SSH keys, etc.). At step 102, the file system contained within the image to be customized is scanned for specific customization filenames (e.g., files named customization.xml). Next, each of these files is parsed (step 103) and responsive to the information contained therein and the environment information obtained at step 101, the file system within the image is modified (step 104). When all of the customization files have been processed (step 105), a new customized virtual machine, suitable for running in the new environment, is booted (step 106) from the customized image.

As mentioned above, within aspects of some embodiments of the present invention, the metadata is stored within the image in particular files with a standard name (such as “customization.xml”) anywhere in the file system contained within the image. Within a presently preferred embodiment of the invention, the metadata is represented in XML, where the defined XML elements have semantics including:
A list of XML files to be patched, and for each one the xpath expression that finds the patch point(s), and standard tokens for what to patch (e.g., new IP address, new hostname, netmask, gateway address, etc).
A list of files to be entirely replaced with relevant other files, and standard tokens for those other files (e.g., files containing SSH host keys).
A list of files to be entirely replaced with relevant other files, where the XML contains the actual content of those other files, and that content may include standard tokens to be replaced with specific data as above.
A list of non-XML files to be patched, and for each one a sed pattern or regexp or similar pattern with special tokens for e.g., new IP address, new hostname, netmask, gateway address, etc.
A command to be run on the file system contained within the image (not necessarily in the target context), with special replacement tokens for the path to the root of the file system, new IP address, etc. In a preferred embodiment, this script is run in a context similar (at least at the file system level) to the target context (relevant file systems mounted, chroot'd appropriately, etc).
A command to be run on the file system while running in the target context (i.e. in the environment that the customization is being performed for after the image has been booted).

Within further aspects of embodiment of the present invention, images are bootable file system images, and thus contain or reference file systems and other related data. In yet further aspects of the present invention, the images contain (instead of or as well) memory images of running virtual machines. The metadata, index files, data to be customized, etc., may be stored in and applied to the memory images as well as (or instead of) file system images.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagram depicted herein is just an example. There may be many variations to this diagram or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fail within the scope of the claims which follow. These claims should be construed to maintain the proper protection for the invention first described.

What is claimed is:

1. A method for the customization of virtual machine images, the method comprising:
identifying a template for the creation of a virtual machine image;
retrieving the virtual machine image template; and
creating a customized virtual machine image from the virtual machine image template, the customized virtual machine image template being created by:
identifying at least one file-system or memory image that is associated with the virtual machine image template;
identifying within the at least one file-system or memory image at least one data set, wherein the at least one data set comprises metadata, the metadata containing information detailing the required execution context customization aspects for at least one specified image subset of the virtual machine;
retrieving execution context-specific information that is required to customize the image subset of the virtual machine; and
modifying the image subset of the virtual machine, wherein the image subset of the virtual machine is modified in accordance with the retrieved execution context-specific information.

2. The method of claim 1, wherein the customized virtual machine is booted from the modified virtual machine image.

3. The method of claim 2, wherein the data set metadata is formatted in XML.

4. A computer program product that includes a computer readable medium useable by a processor, the medium having stored thereon a sequence of instructions which, when executed by the processor, causes the processor to customize virtual machine images for utilization within an execution context, wherein the customization of the virtual machine images are accomplished by:
identifying a template for the creation of a virtual machine image;
retrieving the virtual machine image template; and
creating a customized virtual machine image from the virtual machine image template, the customized virtual machine image template being created by:
identifying at least one file-system or memory image that is associated with the virtual machine image template;
identifying within the at least one file-system or memory image at least one data set, wherein the at least one data set comprises metadata, the metadata containing information detailing the required execution context customization aspects for at least one specified image subset of the virtual machine;
retrieving execution context-specific information that is required to customize the image subset of the virtual machine; and
modifying the image subset of the virtual machine, wherein the image subset of the virtual machine is modified in accordance with the retrieved execution, context-specific information.

5. The method of claim 4, wherein the customized virtual machine is booted from the modified virtual machine image.

6. The method of claim 5, wherein the data set metadata is formatted in XML.
